(19) United States
(12) Patent Application Publication
(10) Pub. No.: US 2010/0133003 A1
(43) Pub. Date: Jun. 3, 2010

(54) IMPLANTABLE MEDICAL ELECTRICAL LEADS INCLUDING COIL ELECTRODES

(75) Inventors: Kevin R. Seifert, Forest Lake, MN (US); Gregory A. Boser, Richfield, MN (US)

Correspondence Address: MEDTRONIC, INC., 710 MEDTRONIC PARKWAY NE, MINNEAPOLIS, MN, 55432-9924, US

(73) Assignee: Medtronic, Inc., Minneapolis, MN (US)

(21) Appl. No.: 12/627,084

(22) Filed: Nov. 30, 2009

Related U.S. Application Data
(60) Provisional application No. 61/118,599, filed on Nov. 29, 2008.

(51) Int. Cl. H01R 4/18; H01R 43/16

(52) U.S. Cl. 174/84 C; 29/874

(57) ABSTRACT

A medical electrical lead employing a conductive wire as an electrode and a method of its manufacture. The electrode includes a first length extending along a first, helical path, between a first end of the wire and a second length of the wire; the second length of the wire extends along a second path between the first length and a second end of the wire. A conductor of the lead may be mounted within the second length of the conductive wire, for coupling thereto, and a junction, preferably including a crimp and a weld, may be formed between the wire and the mounted conductor. Prior to coupling the conductor, the second length of the wire may extend at least 270 degrees and less than 360 degrees about an axis, which is offset from an axis of the first, helical path.

### CROSS-REFERENCE TO RELATED APPLICATIONS

This application claims the benefit of U.S. Provisional Application No. 61/118,599, filed on Nov. 29, 2008. The disclosure of the above application is incorporated herein by reference.

### TECHNICAL FIELD

The present disclosure pertains to implantable medical devices and more particularly to medical electrical leads including coil electrodes.

### BACKGROUND

A medical electrical lead typically includes one or more elongate conductors, each of which electrically couples an electrode of the lead to a corresponding connector contact of the lead. A junction formed between each conductor and the corresponding electrode should add a minimum of electrical resistance to the electrical circuit, which is formed by the electrode, conductor, and corresponding contact, and should have an adequate strength to maintain good contact under operational loading conditions. Although many such conductor-to-electrode junctions are known in the art, there is still a need for improved conductor junctions which, in addition meeting the above criteria, can facilitate manufacturing efficiency of the medical electrical leads, and which do not significantly increase a profile of the leads. Because medical electrical leads are typically constructed to have the lowest possible profile, without compromising functional integrity, reliability and durability, relatively low profile conductive couplings, which do not significantly increase a profile of the lead are also desired. Although some low profile conductive couplings have been previously disclosed, there is still a need for improved couplings which, in addition meeting the above criteria, provide flexibility in the manufacture of various configurations of medical electrical leads.

As lead bodies become smaller and the height of the connections between conductors and electrodes is reduced, it becomes increasing difficult to make low profile junctions that allow conductor coils to be welded to without damaging or significantly affecting the cable. For example, a radially symetrical crimp barrel or crimp sleeve located entirely within a lead lumen as described in U.S. patent application Ser. No. 11/549,284 filed Oct. 13, 2006 may only have a 3 mil wall due to height constraints. The thermal mass, wall thickness and available material to make an effective weld is negligible. Prior designs such as those disclosed in U.S. Pat. No. 5,676,694 issued to Boser et al and incorporated herein by reference in its entirety have provided an extension to the crimp sleeve which extends outward from the lead lumen to the exterior of the lead body, allowing the a weld to an associated electrode coil to be made spaced from the lead conductor. However, further reductions in lead profile are still desirable over leads fabricated using this connector mechanism.

### SUMMARY

The present invention is directed to an implantable medical electrical lead of the type comprising a longitudinally extending insulative body, an elongate conductor extending within the body and an electrode comprising a conductive wire, typically taking the general form of an elongated coil. The wire extends from a first end thereof to a second end thereof and includes a first length, a second length and a transition length extending between the first and second lengths. The first length of the wire extends around the body and between the first end and the transition length, and the second length extends around the conductor, within the body, and between the transition length and the second end. A junction formed between the second length of the wire and the conductor, within the body.

In preferred embodiments of the invention the junction consists of a crimp between the second length of the wire and the conductor and a weld between the second end of the wire and the transition length of the wire. No separate crimp sleeve or welding sleeve is needed, reducing the cross section of the connection and contributing to a reduced over-all lead diameter.

In some embodiments the lead body comprises a multilumen tube; and the conductor extends longitudinally within a lumen of the multilumen tube, the junction being located entirely within the lumen of the multilumen tube. In other embodiments the lead body comprises an inner member and an outer insulative sheath, the conductor being wrapped around the inner member, and the junction being located between the inner member and the outer insulative sheath.

In some preferred embodiments the electrode wire has a substantially rectangular cross-section. The second length of wire may extend around the conductor in a same direction that the first length of wire extends around the body or may extend around the conductor in a direction opposite to that in which the first length of wire extends around the body.

The invention is also directed to a method for manufacturing a medical electrical lead, as described above, comprising mounting a first length of a coiled electrode wire about an insulative body of the lead, mounting an elongate conductor within a second length of the coiled electrode wire and forming a junction between the conductor and the coiled electrode wire by crimping the second length of the coiled wire to the conductor and welding an end of the second length of the coiled wire to the transition length of the coiled wire.

In some embodiments, the elongate conductor is inserted within the lead body prior to forming the junction. In other embodiments, the elongate conductor is inserted within the lead body after crimping. Mounting the conductor within the second length of the coiled electrode wire may comprise inserting the conductor through a gap between the end of the second length and the transition length.

### BRIEF DESCRIPTION OF THE DRAWINGS

The following drawings are illustrative of particular embodiments, and therefore do not limit the scope of the invention. The drawings are not to scale (unless so stated) and are intended for use in conjunction with the explanations in the following detailed description. Embodiments will hereinafter be described in conjunction with the appended drawings, wherein like numerals denote like elements.

FIG. 1A is a perspective view of an implantable medical electrical lead, which may incorporate embodiments of the present invention.

FIGS. 1B-C are cross-section views through section line A-A of FIG. 1A, according to alternate embodiments.

FIG. 2A is a top plan view of a coil electrode, according to some embodiments.

FIG. 2B is an end view of the coil electrode shown in FIG. 2A.

FIG. 2C is an end view of a coil electrode, according to some alternate embodiments.

FIG. 3 is a top plan view of a coil electrode, according to some additional embodiments.

FIG. 4 is a cross-section view through section line B-B of FIG. 1A, according to some embodiments.

FIG. 5 is a flow chart outlining some methods of the present invention.

FIG. 6 is a top plan view of a coil electrode, according to yet further embodiments.

### DETAILED DESCRIPTION

The following detailed description is exemplary in nature and is not intended to limit the scope, applicability, or configuration of the invention in any way. Rather, the following description provides practical illustrations for implementing exemplary embodiments. Examples of constructions, materials, dimensions, and manufacturing processes are provided for selected elements, and all other elements employ that which is known to those of skill in the field of the disclosure. Those skilled in the art will recognize that many of the examples provided have suitable alternatives that can be utilized.

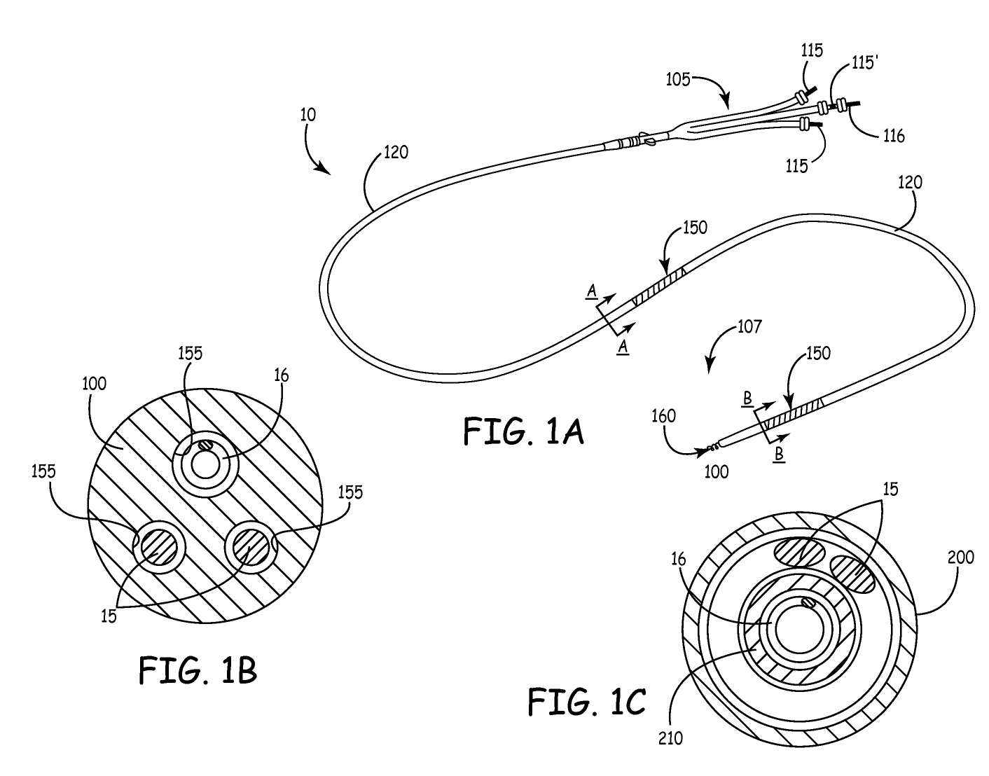

FIG. 1A is a perspective view of an implantable medical electrical lead 10, which may incorporate embodiments of the present invention. FIG. 1 illustrates lead 10 including a proximal connector assembly 105, a distal electrode tip 160 and an elongate body 120, which extends from proximal connector assembly 105 to distal electrode tip 160, and on which coil electrodes 150 are mounted. FIGS. 1B-C are cross-section views through section line A-A of FIG. 1A, according to some alternate embodiments. FIG. 1B shows body 120 formed with a multilumen insulative tube 100, that includes lumens 155 in which conductors 15, 16 extend, while FIG. 1C shows body 120 formed by an inner insulative sheath 210, in which conductor 16 extends, and an outer insulative sheath 200, which surrounds both inner insulative sheath 210 and conductors 15, which are coiled about inner insulative sheath 210. Suitable insulative materials for forming multilumen tube 100 and sheaths 200, 210 include, without limitation, medical grade silicone rubber and polyurethane and combinations thereof. It should be noted that inner insulative sheath and conductor 16 may be replaced with any other suitable type of inner member, or core, about which conductors 15 may be coiled, according to some alternate embodiments. Examples of these other types of inner members include, without limitation, a tensile element lending strength to lead body 120, a fluid injection tube, and a formable member for steering lead body 120. In some embodiments, for example embodiments in which the coil electrode comprises the only electrode, inner insulative sheath 210 and conductor 16 may not be present.

According to the illustrated embodiments, each of conductors 15 couples one of electrodes 150 to a corresponding connector contact 115 of connector assembly 105, and conductor 16 couples tip electrode 160 to a connector contact 116 of connector assembly 105; the conductor 15 that couples the distal most electrode 150 also couples that electrode to a connector contact 115′ of connector assembly 105, for integrated sensing, which is known to those skilled in the art. Those skilled in art will further appreciate that connector assembly 105 may be plugged into a connector module of an implantable medical device, wherein electrical contacts, that correspond to each of the connector contacts, are mounted. According to some embodiments, each of conductors 15, for either of the lead body configurations shown in FIGS. 1B-C, are coupled directly to a portion of the corresponding electrode 150 that extends within lead body 120, as will be described in greater detail below.

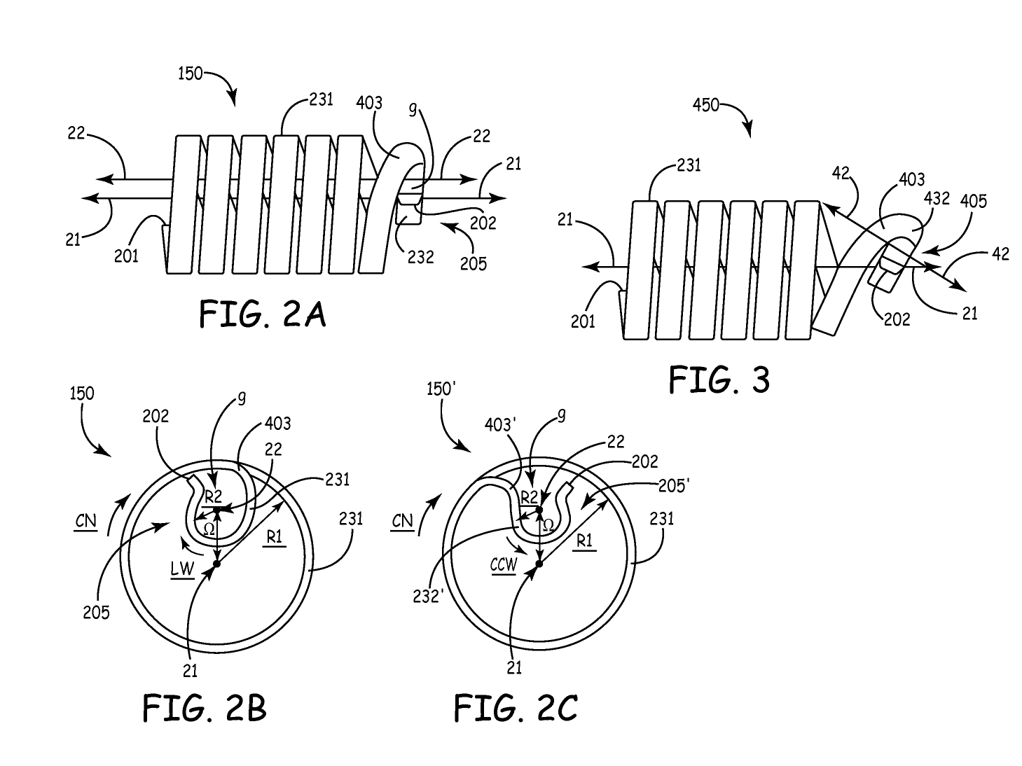

FIGS. 2A-B are a top plan view and a corresponding end view of coil electrode 150, according to some embodiments. FIGS. 2A-B illustrate a conductive wire forming electrode 150 and including a first length 231 and a second length 232, wherein first length 231 extends along a first, helical path, between second length 232 and a first end 201 of the wire, and second length 232 extends along a second path, between first length 231 and a second end 202 of the wire. According to the illustrated embodiment, the first, helical path defines a first radius R1 about a longitudinal axis 21 of electrode 150, and the second path defines a second radius R2 about an offset axis 22, which is offset from longitudinal axis 21 by a single distance O along first radius R1. According to some exemplary embodiments, for Example intended for use in the right hear chambers, first radius R1 is between approximately 0.05 inch and approximately 0.09 inch and second radius R2 is between approximately 0.005 inch and approximately 0.015 inch. Somewhat smaller radii are appropriate in the context of leads for placement in the coronary veins for stimulation of the left heart chambers.

FIG. 2C is an end view of a coil electrode 150′, according to some alternate embodiments. FIG. 2C illustrates coil electrode 150′ formed by a conductive wire, which includes a first length 231, extending about longitudinal axis 21, like the wire of electrode 150, and a second length 232′, which extends between first length 231 and second end 202, like second length 232 of electrode 150, but in a direction opposite to that in which first length 231 extends. With reference to FIGS. 2B-C, first length 231 of both electrodes 150, 150′ is shown extending in a clockwise direction, per arrow CW, and second length 232 of electrode 150 is also shown extending per arrow CW, while second length 232′ of electrode 150′ is shown extending in a counter-clockwise direction, per arrow CCW.

With reference to FIGS. 2A-C, it will be appreciated that first length 231 of each of the conductive wires extends greater than 360 degrees about longitudinal axis 21 to form multiple turns of each coil electrode 150, 150′, which turns define an exposed surface area of each electrode 150, 150′, while second length 232, 232′ of each wire extends less than 360 degrees, but greater than 270 degrees about offset axis 22 to form a clasp 205, 205′ that has a gap g through which a conductor, for example, one of conductors 15, may be inserted for coupling to each second length 232, 232′, as will be described in greater detail below. FIGS. 2B-C further illustrate second end 202 of each of the conductive wires of electrodes 150, 150′ bending outward from the second path about which each of second lengths 232, 232′ extend, for example, to increase an ease with which a conductor, such as conductor 15, may be inserted through gap g.

With further reference to FIGS. 2A-C, it can be seen that offset axis 22 extends in line with longitudinal axis 21, that is, in a same general direction as that in which axis 21 extends; and, it may be appreciated that an orientation of clasp 205, 205′, according to the direction of offset axis 22, can facilitate coupling of a conductor that extends longitudinally along a length of lead body 120, for example, as may be the case when multi-lumen tube 100 is employed (FIG. 1B). However, according to some other embodiments, for example as shown in FIG. 1C, wherein conductors 15 are coiled, or wrapped along a helical path about inner insulation 210, it may be advantageous for offset axis 22 to extend in a direction that is skewed with respect to that of longitudinal axis 21 of electrode 150 so that clasp 205 is better oriented to receive the conductor 15 that extends along the helical path. FIG. 3 is a top plan view of an electrode 450 including a clasp 405 oriented as such. FIG. 3 illustrates a wire, which forms electrode 450, including a second length 432, which extends between first length 231 and second end 202 about a second path which defines a radius about an offset axis 42, which offset axis 42 is offset from axis 21 by a single distance, like axis 22, but which extends in a direction that is skewed with respect to the direction in which longitudinal axis 21 extends.

Those skilled in the art will appreciate that the wire forming any of electrodes 150, 150′, 450 may have any suitable cross-section, for example, round, rectangular, flattened, or otherwise shaped, and may be formed from any suitable biocompatible and biostable material having sufficient resistance to flex fatigue loading. Examples of suitable materials include, without limitation, platinum-iridium alloys, tantalum, tantalum alloys, platinum-iridium clad tantalum and platinum-iridium clad tantalum alloys. According to some preferred embodiments, the wires have a substantially rectangular cross-section, wherein the width thereof extends generally in the direction of longitudinal axis 21, in order to maximize both an electrode surface area defined by the turns about axis 21, and a contact surface area between clasps 205, 205′, 405 and the conductor crimped therein. According to some exemplary embodiments, a wire of any of electrodes 150, 150′, 405 is formed from platinum-iridium clad tantalum and has a rectangular cross-section with a width between approximately 0.005 inch and approximately 0.015 inch and a thickness between approximately 0.001 inch and approximately 0.005 inch.

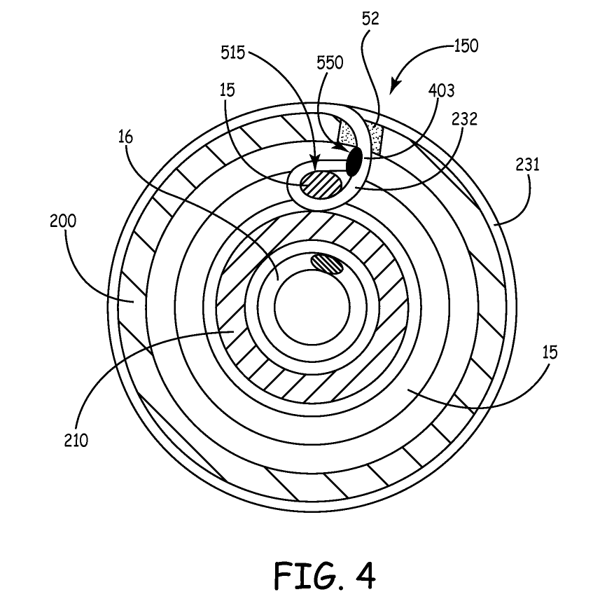

Turning now to FIG. 4, a junction, according to some embodiments, between one of conductors 15 (FIG. 1C) and electrode 150 will be described. FIG. 4 is a cross-section view through section line B-B of FIG. 1A, according to some embodiments. FIG. 4 illustrates first length 231 of the wire, that forms electrode 150, extending around outer insulative sheath 200 of lead body 120, and second length 232 of the wire extending within outer insulative sheath 200, having been passed through an opening 52 thereof, and extending around conductor 15, conductor 15 having been inserted into clasp 205 formed by second length 232, through gap g, as previously described in conjunction with FIGS. 2A-B. In some alternative embodiments, rather than providing an opening 52, the sheath 200 may terminate within the coil electrode allowing the second length 232 to simply extend inward adjacent the termination of sheath 200. In such embodiments, an additional sheath external to the second length 232 of the coil electrode may be provided and the volume between sheath 200 and the additional sheath may be backfilled to stabilize and seal the junction.

According to the illustrated embodiment, the junction between conductor 15 and electrode 150 is located between outer insulative sheath 200 and inner insulative sheath 210. Although not shown, according to some embodiments, a conductive sleeve is fitted about a portion of conductor 15, which extends within clasp 205 of second length 232 of the wire, such that the junction includes the sleeve as an interface between conductor 15 and second length 232 of the wire. The illustrated junction is formed by both mechanical deformation, such as a crimp 515, of second length 232 of the wire about conductor 15, and a weld 550, for example, formed by a laser, between second end 202 of the wire and a transition length 403 of the wire, which transition length 403 is defined as extending between first length 231 and second length 232, and is shown, in FIG. 2B, as being across gap g from second end 202 of the wire.

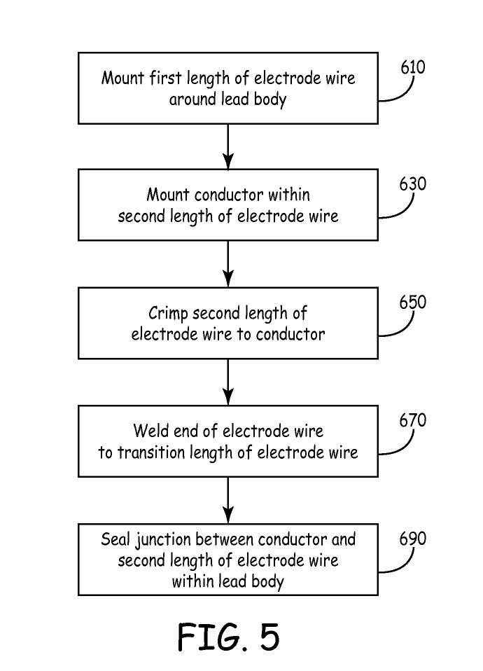

FIG. 4 further illustrates opening 52 sealed with a backfill material (shown with specking), for example, silicone medical adhesive; a tubing band, for example, also formed from medical grade silicone, may surround lead body in proximity to the junction to further seal opening 52. It should be noted that electrode 450 of FIG. 3 may be substituted for electrode 150 in the assembly shown in FIG. 4, according to alternate embodiments wherein the junction is formed in a similar manner, e.g. via crimping and welding. Some methods for manufacturing a lead, such as lead 10 of FIG. 1A, which includes such a junction between a conductor and an electrode, will be described in conjunction with FIG. 5.

FIG. 5 is a flow chart outlining some methods, which will be described in conjunction with the embodiments shown in FIGS. 2A-B and 4. FIG. 5 illustrates an initial step 610 in which a first length of electrode wire, for example, first length 231, is mounted around a lead body. According to a subsequent step 630, a conductor is mounted in a second length of the electrode wire, for example, second length 232 which forms clasp 205. A portion of the conductor, which is mounted within the second length of the electrode wire, may have a conductive sleeve fitted thereabout as previously described. Following step 630, the second length of the electrode wire is crimped to the conductor, per step 650. FIG. 5 further illustrates a step 670, following the crimping of step 650, wherein an end of the wire, for example, second end 202, is welded to a transition length of the wire that extends between the first and second lengths, for example, transition length 403. With reference to FIG. 4, it may be appreciated that opening 52 can provide a window for this welding operation. In a final step 690, of the FIG. 5 flow chart, the junction formed between the conductor and the second length of electrode wire is sealed within the lead body, for example, via a silicone medical adhesive backfill and tubing band, as previously described.

According to some alternate methods, steps 630, 650 and 670 precede step 610, such that the conductor is crimped within the second length of the electrode wire, and the end of the electrode wire is welded to the transition length of the electrode wire, prior to mounting the first length of the wire around the lead body, per step 610. Alternatively, steps 630 and 650 precede step 610, but step 670 follows step 610. If the conductor is joined to the electrode apart from the lead body, the joined conductor could be strung through an opening between an exterior and interior of the lead body, for example, opening 52, as the first length of the electrode wire is mounted around the lead body, per step 610.

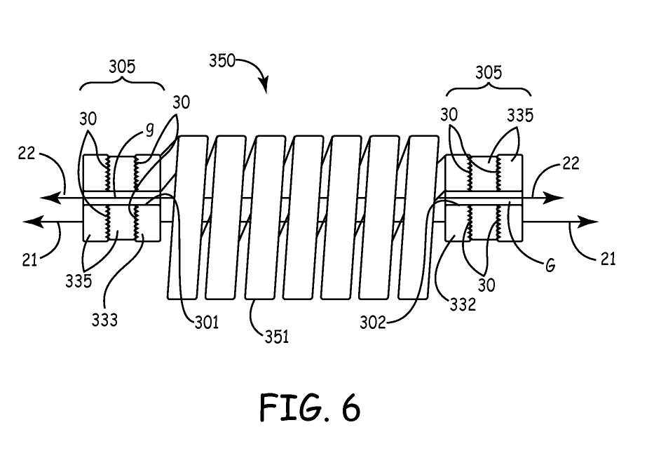

FIG. 6 is a top plan view of a coil electrode 350, according to yet further embodiments, which provides a pair of clasps 305, each having an increased surface area for interfacing with a conductor to form a junction therewith. FIG. 6 illustrates a conductive wire forming electrode 350 and including a first length 331, a second length 332 and a third length 333, wherein first length 331 extends along a first, helical path, between a first end 301 of the wire and second length 332, second length 332 extends along a second path, between first length 331 and a second end 302 of the wire, and third length extends along a third path between first end 301 and first length 331 of the wire. Like electrodes 150, 150′ of FIGS. 2A-C, first, helical path defines a first radius about longitudinal axis 21 of electrode 350, and the second path defines a second radius about offset axis 22, which is offset from longitudinal axis 21 in a manner similar to that illustrated in FIGS. 2B-C. However, unlike electrodes 150, 150′, the wire forming electrode 350 further includes third length 333 located at an end of electrode 350 that is opposite to that where second length is located; and the third path along which third length 333 extends, according to the illustrated embodiment, is approximately concentric with the second path, and defines a radius approximately equal to that defined by the second path.

FIG. 6 further illustrates two pairs of additional wires 335, wherein one pair of additional wires 335 is joined to second length 332 of the wire and extends alongside second length 332 about the second path, and the other pair of additional wires 335 is joined to third length 333 and extends alongside third length 333 about the third path. According to the illustrated embodiment, each additional wire 335 of each pair is coupled, to the other, and each pair is coupled to the corresponding length 332, 333 of the wire forming electrode 350; a fused junction 30 may be formed for each coupling, for example, via laser welding, as described in greater detail, below. With reference to FIG. 6, it will be appreciated that, like electrodes 150, 150′ of FIGS. 2A-C, first length 331 of the conductive wire extends greater than 360 degrees about longitudinal axis 21 to form multiple turns of coil electrode 350, which turns define an exposed surface area of electrode 350, while second and third lengths 332, 333, along with respective pairs of additional wires 335, each extend less than 360 degrees, but greater than 270 degrees about offset axis 22 to each form clasp 305 having gap g through which a conductor, for example, one of conductors 15, may be inserted for coupling of the conductor, in two locations along a length thereof, at either end of electrode 350. With reference back to FIG. 2A, although electrode 150 is shown including only one clasp 205 formed by second length 232 of the wire, it should be noted that, according to alternate embodiments, electrode 150 further includes another clasp formed from a third length of the wire in proximity to first end 201 of the wire to provide for dual coupling with a conductor in a manner similar to that provided by electrode 350.

According to some embodiments, electrode 350 is formed by first winding a single length of wire to form a first plurality of turns, having a first radius, about longitudinal axis 21 and to form two additional sets of a plurality of turns, each having a second, smaller radius, about offset axis 22, at either end of the first plurality of turns. Following winding, the turns of the additional sets are laser welded together to form fused junctions 30, and then a slot is formed through the turns, for example, via laser cutting, electric discharge machining (EDM), or other suitable methods, in order to form gap g. Thus, clasps 305 are formed having a greater length, for example, than clasp 205, to provide increased surface area contact with a conductor crimped therein, which may increase a strength of a junction formed between electrode 350 and the conductor. It should be noted that, although electrode 350 is shown including the two clasps 305, one at either end, alternate embodiments include a single clasp 305, for a single junction with a conductor.

In the foregoing detailed description, the invention has been described with reference to specific embodiments. However, it may be appreciated that various modifications and changes can be made without departing from the scope of the invention as set forth in the appended claims.

What is claimed is:

1. A medical electrical lead comprising:
a longitudinally extending insulative body;
an elongate conductor extending within the body;
an electrode comprising a conductive wire, the wire extending from a first end thereof to a second end thereof and including a first length, a second length and a transition length extending between the first and second lengths;
the first length of the wire extending around the body and between the first end and the transition length, and the second length extending around the conductor, within the body, and between the transition length and the second end;
a junction formed between the second length of the wire and the conductor, within the body, the junction comprising:
a crimp between the second length of the wire and the conductor; and
a weld between the second end of the wire and the transition length of the wire.

2. The lead of claim 1, wherein:
the body comprises a multilumen tube; and
the conductor extends longitudinally within a lumen of the multilumen tube, the junction being located within the lumen of the multilumen tube.

3. The lead of claim 1, wherein the body comprises an inner member and an outer insulative sheath, the conductor being wrapped around the inner member, and the junction being located between the inner member and the outer insulative sheath.

4. The lead of claim 1, wherein the electrode wire has a substantially rectangular cross-section.

5. The lead of claim 1, wherein the second length of wire extends around the conductor in a same direction that the first length of wire extends around the body.

6. The lead of claim 1, wherein the second length of wire extends around the conductor in a direction opposite to that in which the first length of wire extends around the body.

7. A method for manufacturing a medical electrical lead, the method comprising:
mounting a first length of a coiled electrode wire about an insulative body of the lead;
mounting an elongate conductor within a second length of the coiled electrode wire; and
forming a junction between the conductor and the coiled electrode wire;
wherein forming the junction comprises crimping the second length of the coiled wire to the conductor, and welding an end of the second length of the coiled wire to a transition length of the coiled wire, the transition length extending between the first length and the second length.

8. The method of claim 7, further comprising inserting the elongate conductor within the lead body prior to forming the junction.

9. The method of claim 7, further comprising inserting the elongate conductor within the lead body after crimping.

10. The method of claim 7, wherein mounting the conductor within the second length of the coiled electrode wire comprises inserting the conductor through a gap between the end of the second length and the transition length.
